(19) United States
(12) Patent Application Publication
(10) Pub. No.: US 2003/0195999 A1
(43) Pub. Date: Oct. 16, 2003

(54) Method and system for creating a software program deliverable

(76) Inventor: William A. Hetrick, Wichita, KS (US)

Correspondence Address: LSI LOGIC CORPORATION, 1621 BARBER LANE, MS: D-106 LEGAL, MILPITAS, CA, 95035, US

(21) Appl. No.: 10/123,614

(22) Filed: Apr. 16, 2002

(51) Int. Cl. G06F 9/00

(52) U.S. Cl. 709/325

(57) ABSTRACT

The invention includes a method and system of encapsulating an executable portion of a software program deliverable with custom configuration information into a single software program deliverable. The custom configuration information describing the needs of a particular customer is included and provided in a separate configuration data file. The executable portion software program includes functionality that is common to all customers. The executable also includes a sub-set of functionality that is customized for particular customers. The encapsulated, customized software product deliverable is then provided to the customer so as to reduce potential human errors in implementing the customized functionality.

### BACKGROUND OF THE INVENTION

1. Field of the Invention

The present invention is generally directed toward a method and a system for creating a software program deliverable. More specifically, the present invention is directed to creating a software program deliverable that combines a configuration data file with an executable portion of the software program deliverable.

2. Discussion of Related Art

Software programs include instructions that direct microprocessors to perform certain functions. The instructions are typically created in files that are stored on a storage medium, such as a Compact Disk or a computer hard disk drive. The instructions are compiled in a language that is readable by a microprocessor. The microprocessor accesses and executes the compiled instructions to perform in a manner as directed by the compiled instructions.

Microprocessors are tasked to perform many types of functions. An example of one such function may include controlling a Redundant Array of Independent Disk (RAID) storage system. The controlling of a RAID storage system includes directing a manner in which data is managed by the RAID storage system. Such a microprocessor would be found in a RAID controller. The RAID storage system typically stores redundant information across multiple disks under control of one or more RAID controllers within the subsystem. The information includes redundant data provided by a host system as well as redundant data generated and managed by the RAID storage system. The generation and management of the redundant information are transparent to the host system. An example of a host system includes a host operating system, such as Windows developed by Microsoft Corporation. The redundant information is used to enhance the reliability and/or performance of the storage system. For example, when information is lost on one disk of the array, the storage system may continue to operate using the redundant information managed by the storage system on other disks of the array

An example of a single disk in the array is a hard disk drive as typically found in a personal computer. Access to data on the disks is gained through input/output (I/O) operations, such as reading and writing. The RAID controllers that are usually internal to the storage subsystem process these I/O operations. A user working in a host operating system environment of a computer views the multiple disks as a single disk because the redundant information generated and utilized by the RAID storage system and the distribution of information over multiple disks is independent of, and transparent to, the host operating system that is coupled to the RAID storage system.

Occasionally, a customer who acquires a RAID storage system has specific needs of the RAID storage system. These customer needs may include varying functional aspects of the RAID storage system that can be operatively controlled by the one or more RAID controllers. These functional aspects can be implemented with software programs. However, manufacturers of RAID storage systems would quickly become overwhelmed if each software program were customized for each customer need.

One method of customizing software for a variety of customer needs includes building a single software program that includes a suite of customer-derived functions. The customer-derived functions are implemented by defining variables within the software program prior to a compilation of the software program. Thus, each customized function is initialized by variables that are pre-configured in the software program. However, this method is especially time-consuming for the manufacturer since the software program must be compiled for each customized version of software that is produced.

One known solution to this problem is to provide a configuration file that stores information regarding the proper functioning of the system. Particular user or customer needs may be expressed as variables in the configuration data file. This known technique introduces further problems in that the configuration information and associated executable portion of the software are separated. An improper placement of the configuration files on the system can occur by human error. In fact, the configuration files may not be placed on the system at all.

As evident from the above discussion, a need exists for improved structures and methods for creating customized software programs.

### SUMMARY OF THE INVENTION

The present invention solves the above and other problems and advances the state of the useful arts by providing structure and methods of encapsulating an executable portion of a software program deliverable with custom configuration information into a single software program deliverable. The custom configuration information describing the needs of a particular customer is included and provided in a separate configuration data file. The executable portion software program includes functionality that is common to all customers. The executable also includes a sub-set of functionality that is customized for particular customers. The encapsulated, customized software product deliverable is then provided to the customer so as to reduce potential human errors in implementing the customized functionality.

An example of the customized functionality is found in customers who are resellers of the RAID storage system. A reseller of the RAID storage system may embed the customer's, or reseller's, brand name information within the software of the RAID storage system. Other examples of customized functionality could include a power-up delay function for a disk drive of a redundancy group of a RAID storage system, a unit test function that determines a manner in which the software should reply if a volume of the RAID storage system has failed, an inquiry function that determines a manner in which the software should reply if a volume of the RAID storage system does not exist, and a subsystem component polling interval function that assists in detecting faults of a volume of a RAID storage system. The customer related variables could be used to implement these customized functions. The customer related variables could, thus, include at least one of a power-up delay indicator, a unit test indicator, an inquiry indicator, and a polling interval indicator. A configuration data file is generated and maintained as an individual file that includes customer related variables. In accordance with the present invention, the configuration data file is included in a software program deliverable but is separate from an executable portion of the software program deliverable. The executable portion of the software program deliverable accesses the configuration data file to retrieve the customer related variables. Once retrieved, the customer related variables activate functions within the executable portion of the software program deliverable that are relevant to the customer. These activated functions can direct a RAID controller to operate in a manner as desired by the customer.

In one exemplary preferred embodiment of the invention a system creates a software program deliverable. The system includes a configuration data generator configured for generating a configuration data file that includes variables for implementing customizable features within the software program deliverable. The system also includes a compiler configured for generating an executable portion of the software program deliverable. The system also includes an encapsulator communicatively connected to the compiler and to the configuration data generator for encapsulating the configuration data file and the executable portion of the software program deliverable to create a single customized software program deliverable.

In another aspect of the invention, the system includes a database communicatively connected to the configuration data generator for providing the variables.

In another aspect of the invention, the encapsulator includes an encoder configured for receiving the configuration data file and concealing the configuration data file from a user of the single customized software program deliverable.

In another aspect of the invention, the variables include at least one of a power-up delay indicator, a unit test indicator, an inquiry indicator, and a polling interval indicator.

In another aspect of the invention, the set of the software functions includes a sub-set of customized software functions.

Advantages of the invention include an improved maintenance of customer-defined variables by separating the customer-defined variables from executable portions of software program deliverables and filing the customer-defined variables in customer dependent configuration data files. Other advantages include a compiler time savings as a single software program deliverable can be developed and maintained that activates pre-compiled user-defined functions by accessing a relevant customer dependent configuration data files to retrieve customer-defined variables.

### BRIEF DESCRIPTION OF THE PREFERRED EMBODIMENTS

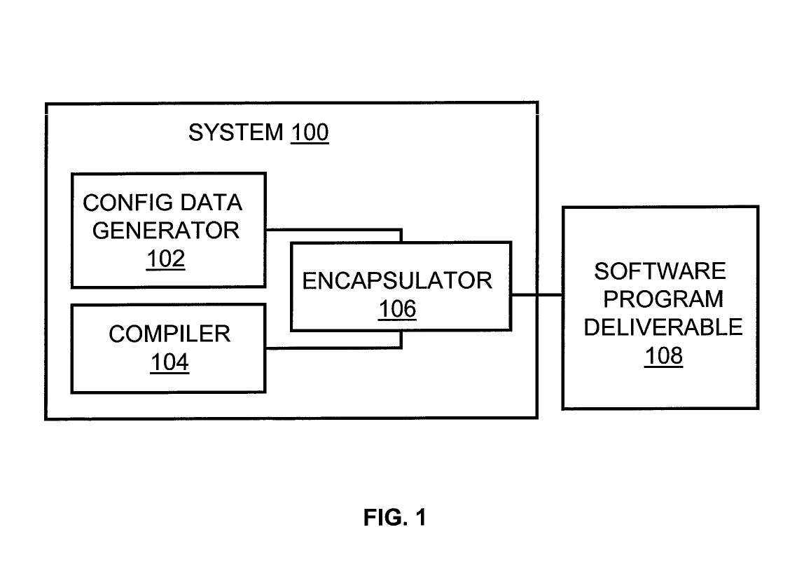

FIG. 1 is a block diagram illustrating an exemplary preferred embodiment of the invention.

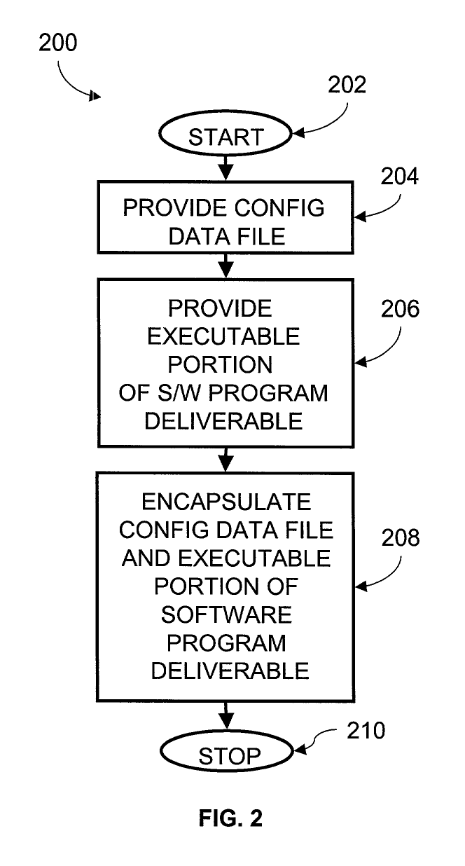

FIG. 2 is a flow chart diagram illustrating an exemplary preferred operation of the invention.

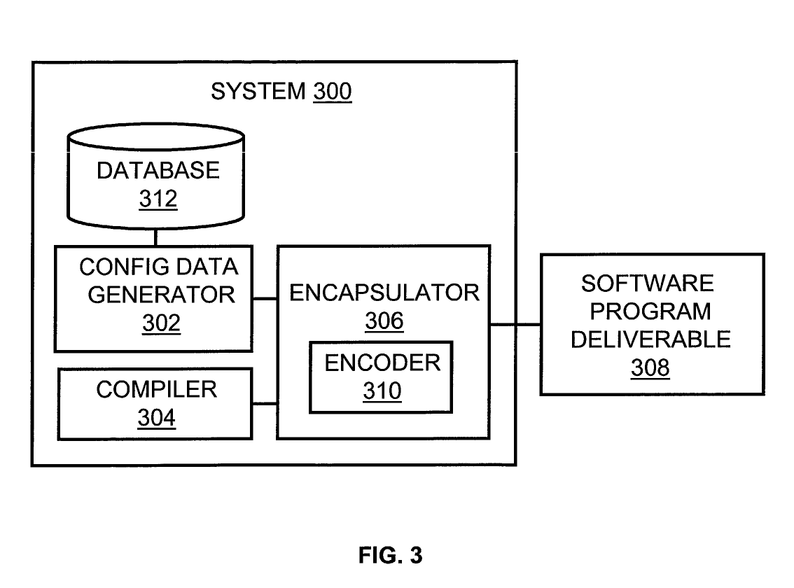

FIG. 3 is a block diagram illustrating another exemplary preferred embodiment operation of the invention.

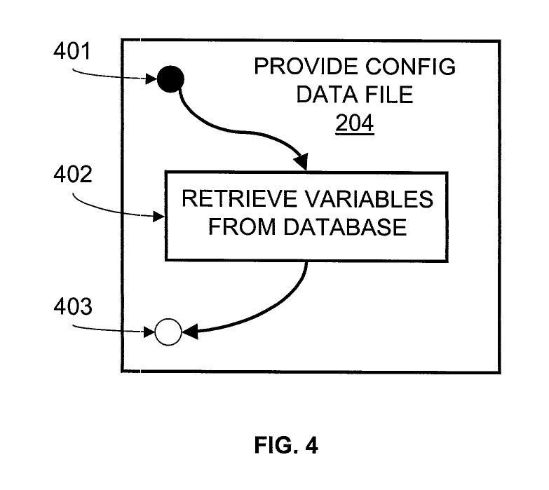

FIG. 4 is a flow chart diagram illustrating a first step of the exemplary preferred operation of the invention.

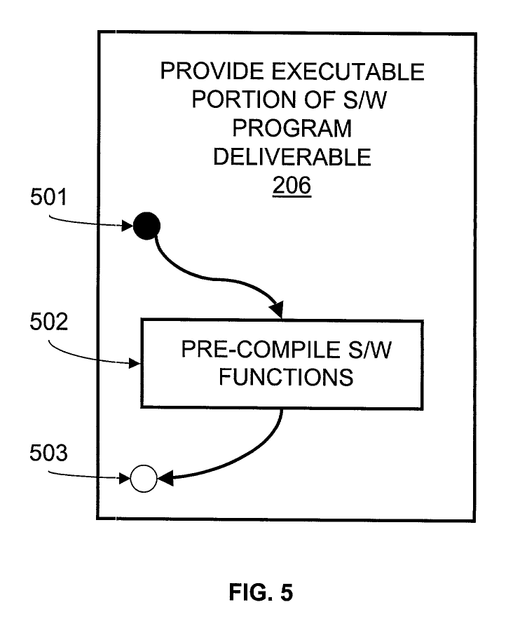

FIG. 5 is a flow chart diagram illustrating a second step of the exemplary preferred operation of the invention.

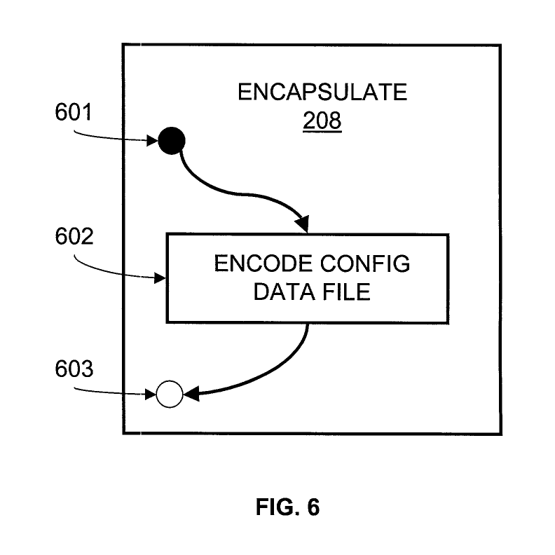

FIG. 6 is a flow chart diagram illustrating a third step of the exemplary preferred operation of the invention.

### DETAILED DESCRIPTION OF THE PREFERRED EMBODIMENTS

While the invention is susceptible to various modifications and alternative forms, a specific embodiment thereof has been shown by way of example in the drawings and will herein be described in detail. Those skilled in the art will appreciate that the features described below can be combined in various ways to form multiple variations of the invention. As a result, the invention is not limited to the specific examples described below, but only by the claims and their equivalents.

With reference now to the figures and in particular with reference to FIG. 1, an exemplary preferred embodiment of the invention is shown in system 100. System 100 is configured to create a software program deliverable. System 100 includes configuration data generator 102 configured to generate a configuration data file that includes, variables for implementing customizable features within the software program deliverable. The variables may indicate functions to be activated within an executable portion of the software program deliverable.

System 100 includes compiler 104 configured for generating the executable portion of the software program deliverable. System 100 includes encapsulator 106 communicatively connected to compiler 104 and to configuration data generator 102 for encapsulating the configuration data file and the executable portion of the software program deliverable to create a single customized software program deliverable 108.

FIG. 2 shows operation 200 of system 100 in one embodiment of the invention. Operation 200 commences in step 202. Configuration data generator 102 provides the configuration data file that includes the variables for implementing customizable features within the software program deliverable in step 204. Compiler 104 provides the executable portion of the software program deliverable in step 206. Encapsulator 106 encapsulates the configuration data file with the executable portion of the software program deliverable to create the single customized software program deliverable 108 in step 208. Operation 200 ends in step 210.

FIG. 3 illustrates a block diagram of system 300 in an exemplary preferred embodiment of the invention. System 300 is configured for creating a software program deliverable. The software program deliverable may be used to operatively control a Redundant Array of Independent Disks (RAID) storage system. System 300 includes configuration data generator 302, compiler 304, encapsulator 306, and database 312. Configuration data generator 302 is configured for generating a configuration data file that includes variables for implementing customizable features within the software program deliverable. Configuration data generator 302 is communicatively connected to database 312 for retrieving the variables. The variables typically include information from a customer of the RAID storage system. For example, a customer may be a reseller of the RAID storage system who may wish to embed the customer's brand name information within the software of the RAID storage system. Other information may include customized functions within the software program deliverable that are relevant to the customer. Examples of the customized functions could include a power-up delay function for a disk drive of a redundancy group of a RAID storage system, a unit test function that determines a manner in which the software should reply if a volume of the RAID storage system has failed, an inquiry function that determines a manner in which the software should reply if a volume of the RAID storage system does not exist, and a subsystem component polling interval function that assists in detecting faults of a volume of a RAID storage system. The variables of the configuration data file could be used to implement these customized functions. The variables could, thus, include indicators for a disk drive of a redundancy group of a Redundant Array of Independent Disks (RAID) storage system, such as a power-up delay indicator, a unit test indicator, an inquiry indicator, and a polling interval indicator. Information that is relevant to the customer can be stored on database 312 to derive the customer variables that activate the customized functions.

Compiler 304 is configured for generating an executable portion of the software program deliverable. Encapsulator 306 is communicatively connected to configuration data generator 302 and compiler 304. Encapsulator 306 is configured for encapsulating the configuration data file and the executable portion of the software program deliverable to create a single customized software program deliverable 308. Encapsulator 306 includes encoder 310 configured for receiving the configuration data file. Encapsulator 306 includes encoder 310 configured for concealing the configuration data file from a user of the single customized software program deliverable 308. Encapsulation of the configuration data file with the executable portion of the software program deliverable can improve customization and maintenance of software program deliverables, such as single customized software program deliverable 308. The encapsulation can improve maintenance by maintaining individual configuration data files that include variables for implementing customized functions for each customer of the RAID) storage system. The encapsulation can improve the development and maintenance of the software program deliverable by maintaining a single software program deliverable that includes a plurality of functions relevant to specific customers. The plurality of functions are initialized and/or activated with respect to customer-derived variables of the configuration data file.

FIG. 4 is a flow chart diagram illustrating step 204 of exemplary preferred operation 200 of the invention. Step 204 enters through entry point 401. Configuration data generator 302 provides the configuration data file that includes the variables for implementing customizable features within the software program deliverable. Customer-derived variables are retrieved from database 312 in step 402. Step 204 then exits through exit point 403.

FIG. 5 is a flow chart diagram illustrating step 206 of exemplary preferred operation 200 of the invention. Step 206 enters through entry point 501. Compiler 304 provides the executable portion of the software program deliverable. Compiler 304 pre-compiles a set of software functions in step 502. The set of software functions can include a sub-set of customized software functions. Step 206 then exits through exit point 503.

FIG. 6 is a flow chart diagram illustrating step 208 of exemplary preferred operation 200 of the invention. Step 208 enters through entry point 601. Encapsulator 306 encapsulates the configuration data file and the executable portion of the software program deliverable to create the single customized software program deliverable 308. Encoder 310 encodes the configuration data file to conceal the configuration data file from a user of the single customized software program deliverable 308 in step 602. Step 208 then exits through exit point 603.

Instructions that perform the above operation can be stored on storage media. The instructions can be retrieved and executed by a microprocessor. Some examples of instructions are software, program code, and firmware. Some examples of storage media are memory devices, tapes, disks, integrated circuits, and servers. The instructions are operational when executed by the microprocessor to direct the microprocessor to operate in accord with the invention. Those skilled in the art are familiar with instructions and storage media.

Advantages of the above embodiments of the invention include an improved maintenance of customer-defined variables by separating the customer-defined variables from executable portions of software program deliverables and filing the customer-defined variables in customer dependent configuration data files. Other advantages include a compiler time savings as a single software program deliverable can be developed and maintained that activates pre-compiled user-defined functions by accessing a relevant customer dependent configuration data files to retrieve customer-defined variables.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A method of creating a software program deliverable, including steps of:
providing a configuration data file that includes variables for implementing customizable features within the software program deliverable;
providing an executable portion of the software program deliverable; and
encapsulating the configuration data file and the executable portion of the software program deliverable to create a single customized software program deliverable.

2. The method of claim 1, wherein providing the executable portion of the software program includes a step of pre-compiling a set of software functions.

3. The method of claim 2, wherein the set of the software functions includes a sub-set of customized software functions.

4. The method of claim 1, wherein the variables include at least one of a power-up delay indicator, a unit test indicator, an inquiry indicator, and a polling interval indicator.

5. The method of claim 1, wherein the step of providing the configuration data file includes a step of retrieving the variables from a database.

6. The method of claim 1, wherein the step of encapsulating includes a step of encoding the configuration data file thereby concealing the configuration data file from a user of the single customized software program deliverable.

7. A system for creating a software program deliverable, including:
a configuration data generator configured for generating a configuration data file that includes, variables for implementing customizable features within the software program deliverable;
a compiler configured for generating an executable portion of the software program deliverable; and
an encapsulator communicatively connected to the compiler and to the configuration data generator for encapsulating the configuration data file and the executable portion of the software program deliverable to create a single customized software program deliverable.

8. The system of claim 7 further comprising a database communicatively connected to the configuration data generator for providing the variables.

9. The system of claim 7, wherein the encapsulator includes an encoder configured for receiving the configuration data file and concealing the configuration data file from a user of the single customized software program deliverable.

10. The system of claim 7, wherein the variables include at least one of a power-up delay indicator, a unit test indicator, an inquiry indicator, and a polling interval indicator.

11. The system of claim 7, wherein the set of the software functions includes a sub-set of customized software functions.

12. A means for creating a software program deliverable, including:
a means for providing a configuration data file that includes variables for implementing customizable features within the software program deliverable;
a means for providing an executable portion of the software program deliverable; and
a means for encapsulating the configuration data file and the executable portion of the software program deliverable to create a single customized software program deliverable.

13. The means of claim 12, wherein the means for providing the executable portion of the software program includes a means for pre-compiling a set of software functions.

14. The means of claim 13, wherein the set of the software functions includes a sub-set of customized software functions.

15. The means of claim 12, wherein the variables include at least one of a power-up delay indicator, a unit test indicator, an inquiry indicator, and a polling interval indicator.

16. The means of claim 12, wherein the means for providing the configuration data file includes a means for retrieving the variables from a database.

17. The means of claim 12, wherein the means for encapsulating includes a means for encoding the configuration data file thereby concealing the configuration data file from a user of the single customized software program deliverable.
